(19) United States
(12) Patent Application Publication
(10) Pub. No.: US 2009/0280299 A1
(43) Pub. Date: Nov. 12, 2009

(54) PROCESS FOR MANUFACTURING A SILICON CARBIDE HEAT EXCHANGER DEVICE, AND SILICON CARBIDE DEVICE PRODUCED BY THE PROCESS

(75) Inventor: Marc Ferrrato, Horgue (FR)

Correspondence Address: YOUNG & THOMPSON, 209 Madison Street, Suite 500, ALEXANDRIA, VA, 22314, US

(73) Assignee: BOOSTEC S.A., BAZET (FR)

(21) Appl. No.: 12/440,640

(22) PCT Filed: Sep. 5, 2007
(86) PCT No.: PCT/FR07/51875

§ 371 Date: Mar. 10, 2009

(30) Foreign Application Priority Data
Sep. 12, 2006 (FR) FR0653680

(51) Int. Cl. B32B 3/02; B32B 18/00; B32B 3/10; B32B 37/02

(52) U.S. Cl. 428/157; 428/454; 428/172; 156/89.11

(57) ABSTRACT

A process for manufacturing a ceramic device of the heat exchanger type includes:—shaping ceramic plates (P0-Pp) and machining these ceramic plates in the unprocessed state on at least one face, so as to produce respective flow paths (Z1A, Z1B) for a first and a second fluid,—stacking the unprocessed plates in order to form an assembly having several levels of flow,—a 1^{st} densification heat treatment (sintering) in order to obtain a pre-assembled densified monolithic block,—a 2^{nd} heat treatment in order to provide the seal of the assembly by migration of a meltable phase (brazing material) to the interfaces of the block.

The present invention relates to a process for manufacturing a device of the silicon carbide heat exchanger type. It also relates to devices of the ceramic heat exchangers type or the exchangers-reactors type made by the process.

The invention more particularly applies to silicon carbide heat exchangers formed by an assembly of face-to-face layers (also so-called superposed layers).

By heat exchangers, are meant heat exchangers allowing heat to be transferred between ambient air and a fluid passing through the exchanger or between two fluids passing through the exchanger, and also exchangers-reactors which allow a chemical reaction to be caused with heat transfer.

There are ceramic exchangers formed with layers assembled face-to-face. The assembling of the plates is a critical step in the elaboration process which strongly influences reliability, performance and cost of these pieces of equipment.

The assembling processes are of two types: A)—assemblies which may be taken apart and B)—those which cannot be taken apart.

A) The first family groups well-known techniques of the art. Mechanical assembling is one of these techniques widely used for building metal exchangers. This technique is applicable to ceramic exchangers. A gasket, most often made of an elastomeric material but which may also be made of metal, is required for providing the seal between the plates. Tightening of the assembly is typically achieved by a screw/nut system.

This technique has two major drawbacks: 1/the introduction of another (elastomer or metal) material less resistant to chemical and/or thermal aggressions but also less resistant to abrasion as compared with ceramic; 2/the necessity of rectifying the ceramic surfaces which are put into contact in order to avoid breaking the plates during tightening. From the art, it is known that this operation is inescapable in the case of brittle materials on the one hand and moreover, it significantly burdens the cost for manufacturing ceramic parts.

Another drawback related to this finishing fabrication operation is the creation of heterogeneity on the hydraulic diameters, the amplitude of which depends on the deformation of the plates stemming from the sintering.

B) The second family groups the adhesive techniques of a) bonding, b) welding, and c) brazing.

Welding/diffusion are the terms used in the case of ceramic materials.

Each of these three techniques has drawbacks which will be described in order to better understand the advantages of the invention.

a) The bonding of ceramics is a known process of the art which has the same drawbacks as those previously associated with techniques applying watertight joints.

As a reminder, these drawbacks are:

1/The introduction of another material (adhesive) which is less resistant to thermo-chemical aggressions as compared with ceramic;

2/The necessity of rectifying the ceramic surfaces so as to eliminate the deformations generated by sintering on the one hand, and to control the surface chemistry of the material to be bonded on the other hand. Both of these features are essential to the mechanical performances of the assembly.

As stated earlier, this rectifying operation significantly burdens the cost for manufacturing a ceramic assembly. Further, the polymer film (the adhesive) may be a limit to heat performance.

b) The welding/diffusion of silicon carbide is a process patented (WO 2006029741) mainly for producing a heat exchanger. It consists of securing several ceramic plates by the joint effect of temperature and pressure, and this without providing any third material. Of course, the pressure levels to be applied (in the hundreds of megapascal (MPa)) impose excellent contact between the plates in order to avoid their breaking. This requirement imposes an operation for rectifying the surfaces in contact with the drawbacks as described and recalled earlier.

c) Brazing, as for it, consists of assembling two parts via a third material (the brazing material) temporarily brought to the liquid state and then re-solidified.

A brazing cycle therefore consists of heating, maintaining a temperature above the melting point of the brazing metal and cooling down to room temperature. The quality of a brazed joint is conditioned by the spreading of the brazing metal (requiring good wetting characterized by a wetting angle <30° in order to obtain a flow of the capillary type), by creating the bond during solidification of the brazing metal either by mechanical squeezing (surface roughness), or by forming a bond at an atomic scale and by maintaining this bond during cooling.

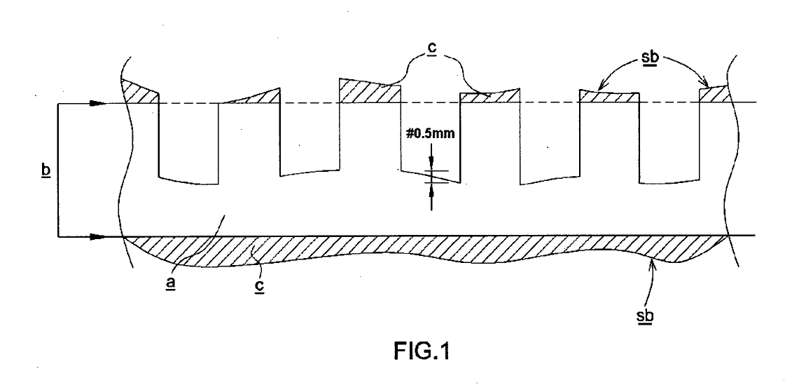

Prior to this high temperature treatment, each of the shaped plates is densified by a heat treatment at high temperature. Each of the plates is then rectified on both of its large faces as illustrated by the diagram of FIG. 1. The thickness of the joint should be as small as possible (less than about hundred microns) and preferentially less than 20 μm in order to impart to the brazed assembly a perfect seal as well as mechanical properties identical with those of the monolithic material.

In order to maintain thin gaskets throughout the brazing process, tightening of the plates at high temperature is required. This mechanical operation requires refractory tools which are often complex.

Further, another drawback of the brazing process is that it imposes a very strict procedure for cleaning the surfaces to be assembled in order to rid them of all contaminants accumulated all along the process (rectification oils, workshop dusts, handling . . . ).

This review of the known processes for assembling ceramic parts shows that the rectifying operation is an inescapable operation and common to the whole of the processes for assembling ceramic plates (adhesive bonding, brazing, welding/diffusion and mechanical assembling).

It is known from the art that this operation significantly burdens the cost of the parts. Furthermore, it adds two other constraints both of a technical order, which also contribute to slowing down the development of this product:
Embrittlement of the parts. Indeed, ceramic is not a ductile material at room temperature, the forces induced by the rectifying grinder cause micro-cracks which weaken the mechanical properties of silicon carbide.
Creation of heterogeneity at the dimensional level of the channels as illustrated by the diagram of FIG. 1. Typically, a ceramic plate of the silicon carbide type has a flatness defect after sintering of the order of 0.5 mm in the case of a surface of about 200×300 mm. Under these conditions, after rectification, an inevitable change in the height of the channels for letting through fluids is observed. The hydraulic diameter is therefore not constant for a same plate. This change is intimately related to the sintering processes and to the deformations that it generates, as well as to the size of the plates to be manufactured. This value cannot be zero and increases with the size of the parts to be made. It is typically located in the 0.1-1 mm range for plates with a compatible dimension for industries using this type of equipment (chemistry, power generation industry, petro-chemistry, pharmaco-chemistry, etc). Typically, the size of an industrial exchanger plate is in the 10 cm-100 cm range.

The present invention gets rid of the whole of these manufacturing constraints by proposing a simple and innovating process which unexpectedly avoids the rectifying step considered as inescapable up to now. This operation, as it was described earlier, is very time-consuming, weakens the mechanical properties of the ceramic (surface micro-cracking) and changes the hydraulic behaviour of the exchanger (reduction of the channels by removal of material). Further, it imposes a cleaning step in order to remove the rectification oils, which are detrimental to the assembly.

The process according to the invention is compatible with the production of small parts but also and especially the production of very large sizes (greater than one meter) and this, regardless of their complexities (which is not the case of the whole of the existing processes). The obtained assembly is perfectly sealed and mechanically very resistant. The hydraulic behaviour is perfectly controlled because the section for letting through the fluids remains constant.

Comparatively with the assembling processes of the art as described earlier, the process according to the invention makes the thereby assembled systems:
more reliable
   1—by avoiding the disturbance caused by rectification,
   2—by guaranteeing a small thickness of the brazing joint (<100 μm).
more economical
   1—by avoiding the rectification operation and associated operations,
   2—by avoiding the design and making of brazing tools,
   3—by avoiding washing operations for the surfaces to be assembled.
more performing
   1—thermally as well as from the hydraulic point of view because the section for letting through the fluid is perfectly under control,
   2—mechanically by retaining the rough sintering surfaces, therefore undisturbed by the rectification step.

The subject matter of the present invention is more particularly a process for manufacturing a device of the silicon carbide heat exchanger type comprising the steps described hereafter:
production of plates by pressing ceramic powder and machining these plates in the unprocessed state on at least one face, so as to achieve respective flow paths for a first and a second fluid,
stacking of the plates is unlike all the known processes achieved in an unprocessed state before heat treatment of the material,
a first heat densification treatment during which bonds are created thereby making the block monolithic,
a second heat treatment in order to provide the seal of the interfaces, therefore of the exchanger.

The first heat treatment consists of densifying and making the plates leak-proof, and for this the temperature level to be attained in the case of natural sintered SiC is above 2,000° C.

The second heat treatment consists of bringing the assembly to the melting point of the brazing material, typically for silicon-based brazing materials, the brazing temperature being located in the range of 1,300° C.-1,500° C.

The brazing paste is deposited prior to starting the second heat cycle. Preferably, this brazing paste is deposited in the areas laid out for this purpose on the sintered exchanger.

The brazing paste generally consists of a mixture of mineral and/or metal powders and of organic binders, these organic additives providing the required plasticity for laying down the viscous mixture in the areas specifically provided for this purpose, these areas (reservoirs) are laid out on the ceramic parts to be assembled and are defined as soon as the upstream exchanger design step.

The machining of ceramic plates in the unprocessed state comprises the production of an active area for heat exchange on each plate and the production of distribution areas, the geometries of which are not limited to planar geometries.

The shaping of the heat exchange ceramics comprises the machining of several independent flow grooves allowing a first fluid to flow between two adjacent plates from a distribution inlet of the plate towards an outlet.

For a given plate, the production of the active heat exchange areas comprises the machining of a flow groove covering the plate from a distribution inlet of the plate towards an outlet and possibly the bevelling of the ends for producing reservoirs.

The subject matter of the invention is also a ceramic device comprising an assembly of ceramic plates forming a sealed monolithic block obtained by the described process.

In order to provide an exchanger function, the monolithic block comprises at least one stack of several plates, each plate further comprising a distribution inlet and outlet for a first fluid and an inlet and outlet for a second fluid.

In order to provide an exchanger-reactor function, the monolithic block comprises at least one stack of several alternating plates of different types, the plates of a first type further comprising a distribution inlet and outlet for a first fluid and the plates of a second type comprising an inlet and an outlet for a second fluid.

The hydraulic diameters of the flow channels for fluids are constant regardless of the selected channel section and of its position on the plate.

The plates include bevelled ends made in the unprocessed state before the brazing step, in order to form reservoir areas for the brazing paste.

Other particularities and advantages of the invention will become clearly apparent upon reading the description which is made hereafter and which is given as an illustrative and non-limiting example and with regard to the figures wherein:

FIG. 1, is a sectional view diagram of an assembled exchanger according to a process of the prior art involving rectification (conventional brazing, welding, diffusion),

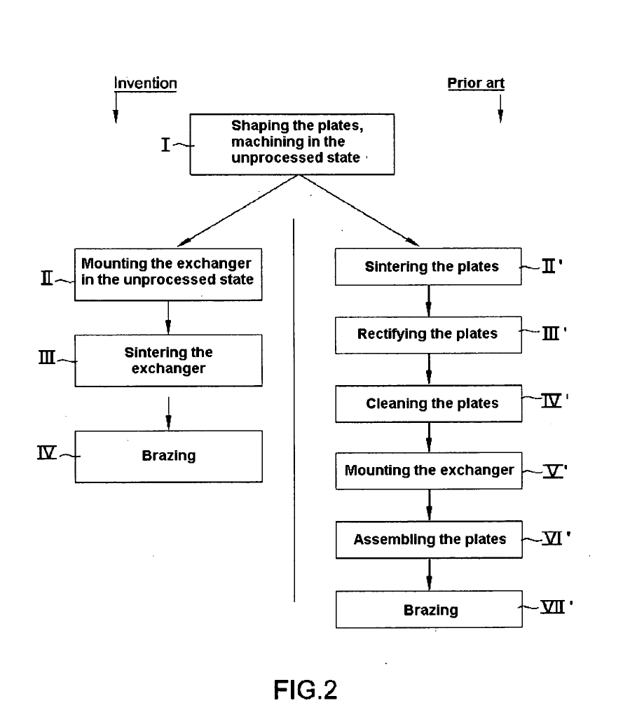

FIG. 2 is a manufacturing flowchart of the inventive process as compared with the conventional process,

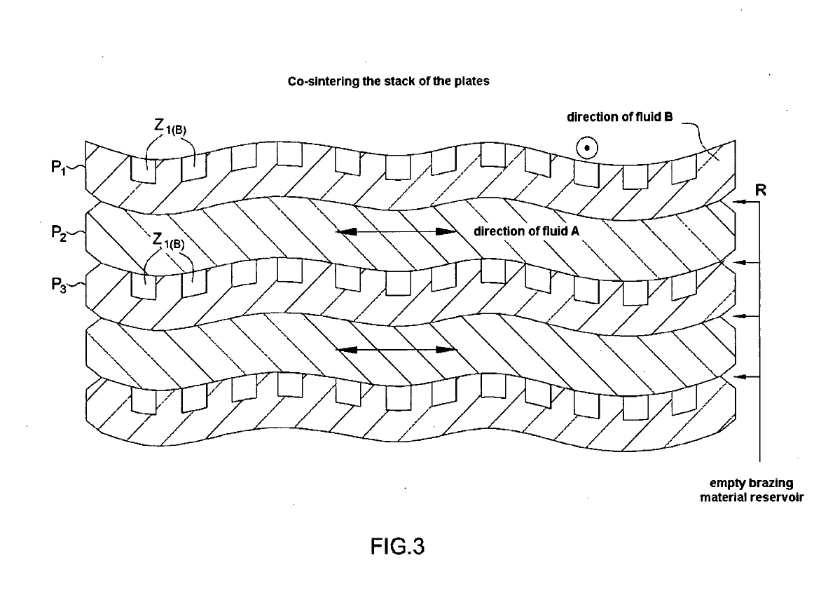

FIG. 3 is a sectional view diagram of an exchanger produced according to the present process after the co-sintering operation,

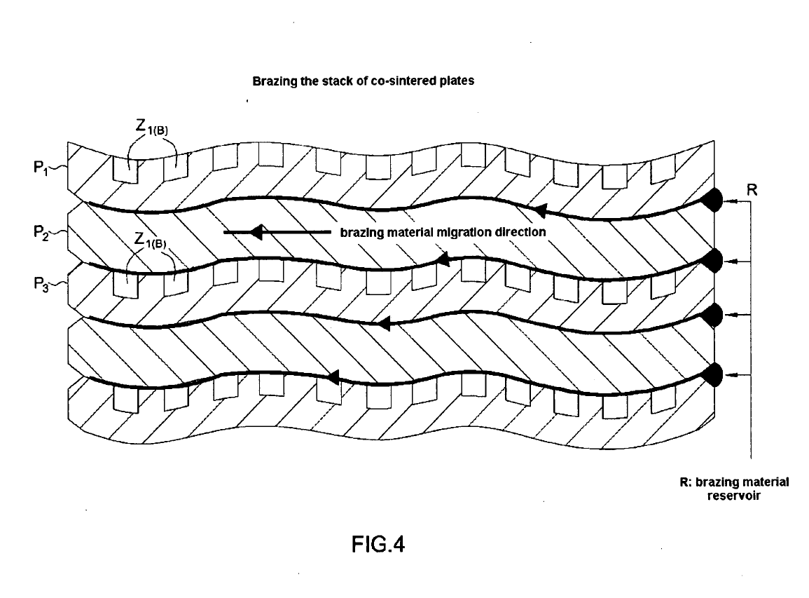

FIG. 4 is a sectional view diagram of an exchanger produced according to the present process during the brazing step,

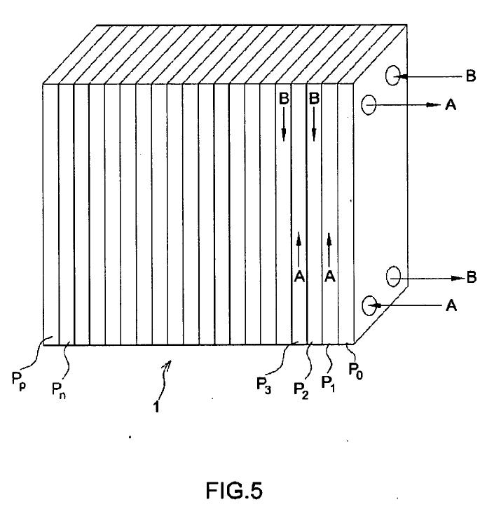

FIG. 5 is a diagram of an exchanger according to the present invention,

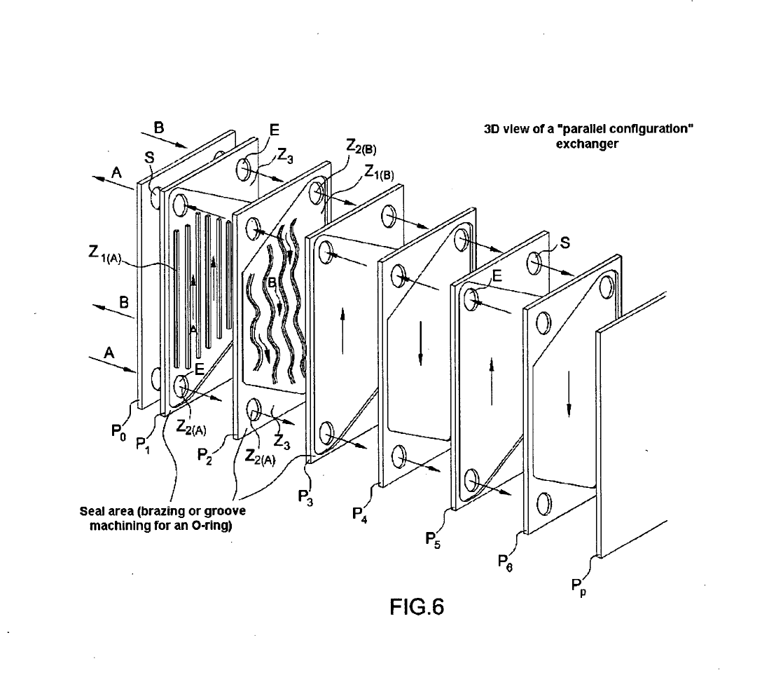

FIG. 6 is an exploded view diagram of an exchanger according to a first embodiment, with which a conventional heat exchanger function may be provided,

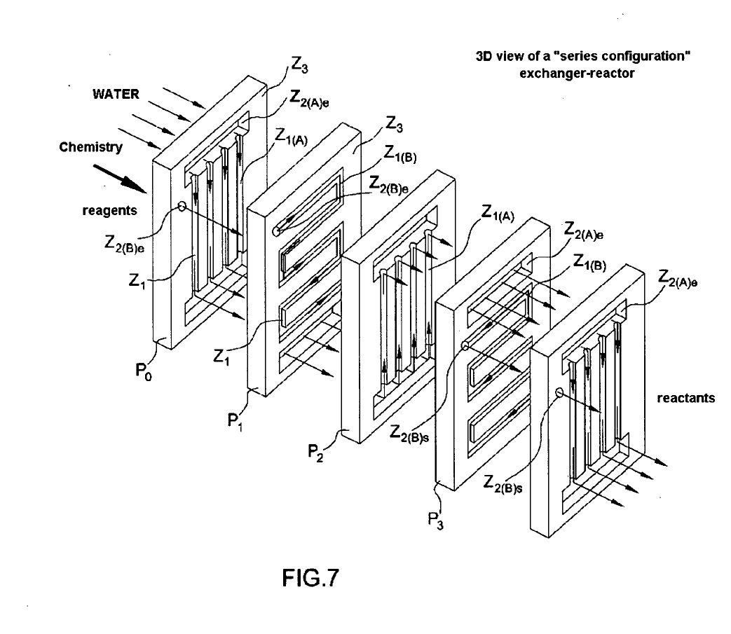

FIG. 7 is an exploded view diagram of an exchanger according to a second embodiment with which an exchanger-reactor function may be provided.

As this may be seen on the diagram of FIG. 1 (prior art), region a illustrates the plate obtained after rectification, lines b illustrate the rectified surfaces ready to be assembled, regions c illustrate the material removed by rectification, and lines sb illustrate the rough sintering surfaces. It may be seen from this figure that the height of the channels is not constant over the whole of the part thereby creating heterogeneities on the hydraulic diameter. On the contrary, this drawback does not exist with the proposed process, as this will be seen from FIGS. 3 and 4.

FIG. 2 illustrates steps I-IV applied by the process which is the subject matter of the invention, and steps I, II′-VII′ correspond to the steps of a process of the prior art.

Steps I-IV of the invention are the following:

I—Shaping the plates is achieved by pressing ceramic powder and machining these plates in the unprocessed state on at least one face, in order to make respective flow paths for a first and second fluid,

II—The mounting of the exchanger in the unprocessed state, unlike all the known processes, consists of stacking the plates in the unprocessed state before heat treatment of the material. The plates are stacked according to the final arrangement as specified by the requirement of the client.

III—The sintering of the exchanger corresponds to the first heat treatment and with it a monolithic block may be obtained, which may be handled and is chemically and physically suited to the brazing operation. The temperature level to be attained in the case of natural sintered SiC is above 2,000° C. The plates after this operation are densified and leak-proof.

IV—The second heat treatment enables the sealing of the interfaces to be obtained and it is distinct from the first treatment by the temperature level (<2,000° C.) and by the nature of the atmosphere (primary vacuum). The brazing paste deposited beforehand will melt during this treatment. A liquid phase forms and it will migrate towards the interfaces of the block densified beforehand. The seal is obtained upon solidification of this liquid phase.

Thus, the operation for preparing the sintered surfaces before assembly is avoided. The plates have the same flatness variations as illustrated by FIGS. 3 and 4, these variations not exceeding 0.5 mm.

With the first heat treatment:
1—the material may be densified,
2—good cohesion may be provided to the assembled block in order to i/allow its subsequent handling, ii/allow the brazing paste to be laid down and iii/make it possible to do without the required tightening tools for the brazing operation.
3—interfaces adapted to the brazing material may be generated, which is expressed in terms of characteristics of the generated surfaces by: 1)—a surface/brazing material wetting angle <30°, 2)—a thickness of play between plates of less than about a hundred microns. Measurements were made which gave a thickness for the joint from 30 to 50 μm.
4—Unexpectedly, the process according to the invention in the particular case of silicon carbide plates and of a silicon-based brazing material leads to the generation of surfaces meeting these criteria.

The second heat treatment for brazing is a heat cycle totally differentiated from the first, mainly by the much lower temperature level. Achieving both of these heat treatments in a single step is not, for example, conceivable because the brazing paste does not withstand the conditions of the first treatment. On the other hand, the same oven may be used for each of these steps. The most practical solution is to dedicate an oven for each operation.

The brazing paste is deposited prior to starting the second heat cycle in the areas laid out for this purpose during step I) on the sintered exchanger. This paste generally consists of a mixture of mineral and/or metal powders and of organic binders.

These organic additives impart the required plasticity for laying the viscous mixture in the areas specifically provided for this purpose. These areas (reservoirs) are laid out on the ceramic parts to be assembled. They are defined as soon as the upstream exchanger design step.

The proposed process is particularly advantageous because it very significantly simplifies the building of exchangers with ceramic plates by eliminating the rectification operation as well as the assembling operations for brazing. The absence of pressure to be applied on the plates to be assembled is also an asset which provides increased freedom for the designer of exchange devices, in particular for designing connector engineering systems. In particular fully ceramic fluid collectors may be assembled according to the present invention. Absence of pressure is naturally an asset for making large size exchangers (larger than an A4 format).

The diagrams of FIGS. 3 and 4 are sections, given as an indication among many possible examples, of a cross-flow exchanger obtained by the process of the invention.

In these FIGS. 3 and 4, the geometrical characteristics of the interfaces may be better seen. FIG. 3 corresponds to the co-sintering step for the stack of plates and illustrates good geometrical agreement from one plate to the other. During the co-sintering step (FIG. 3), because of ductility of the ceramic at its sintering temperature, the plates deform in an identical way, this mechanism provides good contact between each plate, compatible with the requirements of the brazing operation (joint thickness <100 microns). With the generated space being smaller than about a hundred microns, the brazing material may flow over the whole of the surfaces to be sealed by capillary migration of the brazing material according to the diagram of FIG. 4.

The diagram of FIG. 4, illustrates a section of a cross-flow exchanger produced according to the process. It more particularly corresponds to the brazing step, brazing paste having been put into the reservoirs R. This diagram shows that the hydraulic diameter is the same on the whole of the part (exchanger). The interfaces are filled with brazing material providing the seal and the mechanical properties of the assembly.

The description which follows is given as an example for illustrating two devices produced by applying the process. The diagrams of FIGS. 5, 6 and 7 illustrate these devices as 3D views.

FIG. 5 illustrates the monolithic aspect of the exchanger 1, produced in accordance with the process of the invention.

The exchanger consists of plates P1, P2, . . . Pn assembled together. These plates have a general identical shape and thus form after assembly a monolithic block with inlets and outlets for the fluids A, B.

Each plate is obtained by pressing ceramic powder and machining the ceramic in the unprocessed state on at least one face. With this machining, it is possible to produce the flow path for the fluids which comprises the active area and the distribution areas. With the machining, it is possible to also produce sealed areas on the plates. The areas for distributing fluids allow the fluids to be entered, the active areas to be reached and the fluids to flow out.

A first type of plates is machined in order to form the path for a first fluid A and a second type of plates is machined for forming the path for a second fluid B.

In the given examples, the machining of the various areas is achieved on a single face of each plate.

Upon assembly, the plates of the first type and of the second type alternate with each other. By stacking the plates, it is possible to form a monolithic block having several levels of flow.

Assembling the plates is achieved by a first heat treatment so as to cook the ceramic and obtain a monolithic block which may be handled and is suited for the next brazing operation which will provide to the assembly the thereby required seal for the heat exchanger or exchanger-reactor function.

In FIGS. 6 and 7, the areas formed on each plate may be better seen.

FIG. 6 illustrates the exemplary heat exchanger with a flow in the <<parallel>> type configuration.

FIG. 7 illustrates an exemplary exchanger-reactor with a flow of the <<series>> type.

The embodiments illustrated by FIGS. 6 and 7 will now be detailed.

In FIG. 6, the plates P1, P3, P5 allow the flow of fluid A. Each plate for this purpose includes a heat exchange area provided with channels Z1(A). This area is the result of machining of the ceramic plate in the unprocessed state forming independent rectilinear or sinuous independent grooves. These grooves form channels or flow paths for the fluid which arrives through an inlet E and which is directed towards an outlet S made in the plate.

The inlets and outlets are orifices passing through the plates. Each plate includes an inlet and an outlet for each fluid. The inlets and outlets machined on the plates form the distribution areas Z2(A) and Z2(B).

A sealed area Z3 is machined for separating the distribution areas Z2(B) of fluid B from the distribution areas Z2(A) and the flow areas Z1(A) of fluid A.

In the same way, the plates P0, P2, P4 respectively include flow areas Z1(B) for the fluid B, distribution areas Z2(b) for this fluid and sealed areas Z3. The path machined for fluid B may have the same route as for fluid A or a slightly different route while substantially following the same direction in order to optimize the exchange surface.

The machining of the distribution areas is performed at the four corners of the plates. When the plates are assembled, the orifices are facing each other. Producing these distribution areas is therefore a simple operation because it is an identical operation for all the plates forming the exchanger.

The thereby machined plates are stacked according to the configuration to be obtained and then heat-treated at adequate temperatures (>2,000° C. in the case of SiC) in order to obtain both the seal of the plates and cohesion of the stack of plates. The thereby formed block is made definitively leak-proof during the last step which consists of causing a brazing material to migrate to the interfaces. For this, the brazing material is deposited beforehand at room temperature on the sintered block from the reservoirs R. The assembly is then brought to the melting temperature of the brazing material; typically for silicon-based brazing materials, the brazing temperature is located in the 1,300° C.-1,500° C. range.

Of course, the block illustrated in FIG. 5 includes an end-of-flow plate Pp which does not include any machining.

The exchanger may also be framed by ceramic plates so as to increase the seal on the faces which do not include any inlet or outlet. These plates may be attached to the block by brazing.

FIG. 7 illustrates a second embodiment on an exchanger according to the proposed process. This second embodiment corresponds to the production of an exchanger-reactor. In this case, the first fluid A is, for example, water and the second fluid B consists of chemical reagents.

The plates are of two types. For the first type of plates such as P0, P2, P4, each plate includes a flow area Z1(A) made by machining independent parallel rectilinear grooves connecting a distribution area Z2(A)e forming an inlet for the fluid A towards a distribution area Z2(A)s forming an outlet for this fluid. These distribution areas are in the form of a window extending over the width of the flow area.

The plates of the 2^{nd} type include a flow area Z1(B) for the second fluid, made by machining a serpentine groove, one end of which coincides with a distribution area Z2(B)e of the second fluid. This area forms an inlet for fluid B. The other end of the serpentine coincides with a distribution area Z2(B)s of the second fluid forming an outlet for this fluid.

The distribution areas of the second fluid made on the plates of the second type appear as orifices.

1. A process for manufacturing a device of the ceramic heat exchanger type, characterized in that it comprises the following steps:
shaping ceramic plates and machining these ceramic plates in the unprocessed state on at least one face, so as to produce respective flow paths for a first and a second fluid,
stacking the unprocessed plates in order to form an assembly having several levels of flow,
a 1^{st} heat treatment for densification (sintering) so as to obtain a pre-assembled densified monolithic block,
a 2^{nd} heat treatment in order to provide the seal of the assembly by migration of a meltable phase (brazing material) to the interfaces of the block.

2. The manufacturing process according to claim 1, characterized in that for the first heat treatment, the attained temperature level in the case of natural sintered SiC is above 2,000° C.

3. The manufacturing process according to claim 1, characterized in that the second heat treatment consists of bringing the assembly to the melting temperature of the brazing material, i.e. typically for silicon-based brazing materials, a brazing temperature in the range of 1,300° C.-1,500° C.

4. The manufacturing process according to claim 1, characterized in that the brazing paste is deposited prior to the starting of the second heat cycle in the areas arranged (R) for this purpose on the sintered exchanger.

5. The manufacturing process according to claim 1, characterized in that the brazing paste consists of a mixture of mineral and/or metal powders and of organic binders.

6. The process for manufacturing a ceramic heat exchanger according to claim 1, characterized in that the machining of the ceramic plates in the unprocessed state comprises the achievement on each plate of an active heat exchange area and the production of distribution areas, the geometries of which are not limited to planar geometry.

7. The process for manufacturing a ceramic heat exchanger according to claim 1, characterized in that the shaping of the heat exchange ceramics comprises the machining of several independent flow grooves allowing a first fluid to flow between two adjacent plates from a distribution inlet of the plate towards an outlet.

8. The process for making a ceramic heat exchanger according to claim 6, characterized in that for a given plate, the production of the active heat exchange areas comprises the machining of a flow groove covering the plate from a distribution inlet of the plate towards an outlet.

9. A ceramic device of the heat exchanger type, characterized in that it comprises an assembly of ceramic plates (P1, Pp) forming a sealed monolithic block, said device being obtained by the process according to claim 1.

10. The ceramic device according to claim 9, characterized in that the monolithic block comprises at least one stack of several plates (P1, Pp), each plate further comprising a distribution inlet and outlet (Z2A) for a first fluid A and an inlet and outlet (Z2B) for a second fluid B, the device being thereby able to provide an exchanger function.

11. The ceramic device according to claim 9, characterized in that the monolithic block comprises at least one stack of several alternating plates (P1, Pp) of a different type, the plates of a first type further comprising a distribution inlet and outlet (Z2A) for a first fluid A, and the plates of a second type comprising an inlet and an outlet (Z2B) for a second fluid B, the device being thereby able to provide an exchanger-reactor function.

12. The ceramic device according to claim 9, characterized in that the hydraulic diameters of the flow channels (Z1A, Z1B) of the fluids are constant regardless of the selected channel section and its position on the plate.

13. The ceramic device according to claim 9, characterized in that the plates include bevelled ends before the brazing step in order to form reservoir areas (R) for the brazing paste.

14. The manufacturing process according to claim 2, characterized in that the second heat treatment consists of bringing the assembly to the melting temperature of the brazing material, i.e. typically for silicon-based brazing materials, a brazing temperature in the range of 1,300° C.-1,500° C.

15. The manufacturing process according to claim 3, characterized in that the brazing paste is deposited prior to the starting of the second heat cycle in the areas arranged (R) for this purpose on the sintered exchanger.

16. The manufacturing process according to claim 3, characterized in that the brazing paste consists of a mixture of mineral and/or metal powders and of organic binders.

17. The manufacturing process according to claim 4, characterized in that the brazing paste consists of a mixture of mineral and/or metal powders and of organic binders.

18. The process for making a ceramic heat exchanger according to claim 7, characterized in that for a given plate, the production of the active heat exchange areas comprises the machining of a flow groove covering the plate from a distribution inlet of the plate towards an outlet.

19. The ceramic device according to claim 10, characterized in that the hydraulic diameters of the flow channels (Z1A, Z1B) of the fluids are constant regardless of the selected channel section and its position on the plate.

20. The ceramic device according to claim 10, characterized in that the plates include bevelled ends before the brazing step in order to form reservoir areas (R) for the brazing paste.
